(19) United States
(12) Patent Application Publication
(10) Pub. No.: US 2008/0101052 A1
(43) Pub. Date: May 1, 2008

(54) HINGE ASSEMBLY AND WIRELESS MOBILE TERMINAL HAVING THE SAME

(75) Inventors: Chung Jin LEE, Seongnam-si (KR); Chang Ki Lee, Seoul (KR)

Correspondence Address: THE FARRELL LAW FIRM, P.C., 333 EARLE OVINGTON BOULEVARD, SUITE 701, UNIONDALE, NY, 11553, US

(73) Assignee: SAMSUNG ELECTRONICS CO., LTD., Suwon-si (KR)

(21) Appl. No.: 11/777,866

(22) Filed: Jul. 13, 2007

(30) Foreign Application Priority Data
Oct. 31, 2006 (KR) 2006-0106481

(51) Int. Cl. H04B 1/03

(52) U.S. Cl. 361/814

(57) ABSTRACT

A hinge assembly is provided that reduces the SAR value and improves the radiating performance of an antenna for wireless mobile terminals, and a wireless mobile terminal having the hinge assembly is provided. The hinge assembly includes a conductive hinge, and contact connectors for selectively electrically connecting opposite ends of the hinge to ground portions of a body and a folder. The hinge has two coupling portions formed at the opposite ends thereof. One part of the contact connectors is coupled to one of the coupling portions and another part of the contact connectors is connected to the ground portion of one of the body and the folder, and thus electrical connections between the hinge and the ground portions are enabled or disabled according to the position of the contact connector coupled to the coupling portions and rotation of the contact connector.

### PRIORITY

This application claims priority the benefit under 35 U.S.C. § 119(a) of a Korean Patent Application filed in the Korean Intellectual Property Office on Oct. 31, 2006 and assigned Serial No. 2006-0106481, the full contents of which are incorporated herein by reference.

### BACKGROUND OF THE INVENTION

1. Field of the Invention

The present invention relates to a hinge assembly and a wireless mobile terminal having the hinge assembly, and in particular, to a hinge assembly that reduces the specific absorption rate (SAR) value and improves the radiating performance of an antenna, and to a wireless mobile terminal having the hinge assembly.

2. Description of the Related Art

As wireless mobile terminals come into wider use, there has been discussion about the harmfulness to the human body of electromagnetic waves emitted during use of the wireless mobile terminals. The SAR value is a standard for judging harmfulness to the human body of electromagnetic waves emitted from wireless mobile terminals. Here, the SAR value represents a rate of absorption of electromagnetic waves emitted from wireless mobile terminals into the human body.

The greater the SAR value, the more harmful to the human body, and thus many national governments have established an allowable SAR value for the human body, particularly the head, and have enforced compliance of the SAR standard. The United States, Australia and Canada have adopted an allowable SAR value of 1.6 W/kg, Europe and Japan have adopted an allowable SAR value of 2.0 W/kg, and as South Korea have established the same allowable SAR value as that of the U.S., i.e. 1.6 W/kg in 2002, and requires indication of the SAR value and the influence and numerical value of electromagnetic waves affecting the human body in all wireless mobile terminals available for sale from December 2002 and thereafter.

The SAR value is closely related to a near field of electromagnetic waves emitted from antenna devices of wireless mobile terminals, and thus it is related to transmission power of the wireless mobile terminals, antenna characteristic and housing type. Therefore, a conventional method for reducing the SAR value uses a directional antenna device, a separate shield plate or an electromagnetic wave absorber to shield or absorb electromagnetic waves emitted from the terminal to the user.

However, the method using a directional antenna device has a complex configuration, and thus goes against the trend of market toward miniaturization. The method using a separate shield plate or electromagnetic wave absorber has different effects according to properties of materials and its attached position, and a result in complex manufacturing process.

Further, when a wireless mobile terminal is used, generally the wireless mobile terminal is held by one hand and close to the head of the user, and thus a frequency shift may occur by the influence of the human body. In this case, the frequency shift may reduce the radiating performance of the antenna.

To solve the problems, a folder type wireless mobile terminal uses a conductive hinge so as to ground to a wiring substrate of a body of the terminal or a wiring substrate of a folder, or to electrically conductive layers formed in a body case and a folder case.

The grounding method is not commonly applied to all wireless mobile terminals, and thus in some instances, the above-mentioned grounding may cause the reduced performance of an antenna according to the type of wireless mobile terminals.

At present, therefore, a hinge should be configured differently according to the type of wireless mobile terminals so as to reduce the SAR value and optimize the performance of an antenna.

### SUMMARY OF THE INVENTION

Therefore, it is an aspect of the present invention to reduce the SAR value and improve the radiating performance of an antenna according to wireless mobile terminals that use the same hinge assembly.

It is another aspect of the present invention to reduce the SAR value or optimize the performance of an antenna according to the opening or closing of a folder.

It is another aspect of the present invention to selectively enable or disable grounding of a hinge according to the type of a wireless mobile terminal.

In order to achieve the above-mentioned aspects, the present invention provides a hinge assembly that is selectively connected to ground portions of a body and a folder to reduce the SAR value and optimize the performance of an antenna, and a wireless mobile terminal having the hinge assembly.

According to an exemplary embodiment of the present invention, a hinge assembly for a wireless mobile terminal for connecting a body having a ground portion to a folder having a ground portion includes an electrically conductive hinge and contact connectors. The hinge has two coupling portions formed at opposite ends thereof. Each of the contact connectors has one part coupled to one of the coupling portions and another part connected to the ground portion of one of the body and the folder, for enabling or disabling electrical connections between the hinge and the ground portions according to the position of the contact connector coupled to one of the coupling portions and rotation of the contact connector.

Preferably, the hinge includes an electrically conductive hinge body, and two coupling portions protruding outwards at opposite ends of the hinge body. The two coupling portions are located on the axis of rotation of the hinge body.

Preferably, each of the coupling portions has coupling protrusions extending in the direction of the axis of rotation of the hinge body, and contact pads arranged along the outer periphery of the coupling protrusions in the direction of the axis of rotation of the hinge body. Preferably, the coupling protrusions have an electrical conductivity opposite to that of the contact pads.

Preferably, each of the contact connectors includes a first connecting portion having an insertion groove into which the coupling portion is inserted; and a second connecting portion integrated with the first connecting portion and connected to the ground portion. The first connecting portion has a contact protrusion formed on the inner periphery of the insertion groove and contacted with the outer periphery of the coupling protrusions and with the contact pads. The first connecting portion further has at least one dummy contact protrusion formed on the inner periphery of the insertion groove. The contact protrusion and the dummy contact protrusion are arranged at a predetermined angle with regard to the center of the insertion groove.

Preferably, each of the coupling portions includes a plurality of peripheral pads and a plurality of the contact pads arranged along the outer periphery of the coupling protrusion corresponding to the position of the contact protrusion according to the opening or closing of the folder. When the folder is closed, a first peripheral pad, a second peripheral pad, a third contact pad and a fourth contact pad are arranged in a sequential order along the outer periphery of the coupling protrusions corresponding to the position of the contact protrusion, and when the folder is open, a fifth peripheral pad, a sixth contact pad, a seventh peripheral pad and an eighth contact pad are arranged in a sequential order on the outer periphery of the coupling protrusions corresponding to the position of the contact protrusion, wherein an angle between an nth pad and an (n+4)th pad (where n is a natural number from 1 to 4) is equal to an open angle of the folder.

According to another exemplary embodiment of the present invention, a wireless mobile terminal having a hinge assembly includes a body having a first ground portion, a folder having a second ground portion, and the hinge assembly for connecting a portion of the folder to a portion of the body and for rotatably connecting the folder and the body.

Preferably, the body includes a body case having a first electrically conductive layer formed on an inner surface, and a first wiring substrate embedded in the body case and having a first ground layer, wherein the first ground portion is at least one of the first electrically conductive layer and the first ground layer.

Preferably, the folder includes a folder case having a second electrically conductive layer formed on an inner surface, and a second wiring substrate embedded in the folder case and having a second ground layer, wherein the second ground portion is at least one of the second electrically conductive layer and the second ground layer.

### BRIEF DESCRIPTION OF THE DRAWINGS

The above and other aspects, features and advantages of the present invention will be more apparent from the following detailed description in conjunction with the accompanying drawings, in which:

FIG. 1 is a schematic view of a wireless mobile terminal having a hinge assembly in accordance with an exemplary embodiment of the present invention.

FIG. 2 is an exploded perspective view of the hinge assembly of FIG. 1.

FIGS. 3A to 3D are cross-sectional views illustrating a first connecting portion of a second contact connector coupled to a second coupling portion of FIG. 2.

FIG. 4 is a view illustrating a first ground portion and a second ground portion connected to the hinge assembly of FIG. 2.

### DETAILED DESCRIPTION OF EXEMPLARY EMBODIMENTS

Hereinafter, exemplary embodiments of the present invention are described in detail with reference to the accompanying drawings.

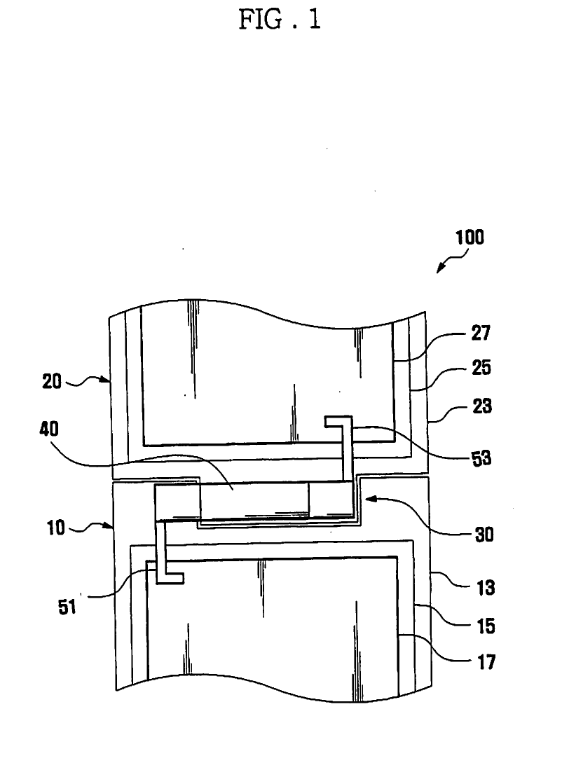

FIG. 1 is a schematic view of a wireless mobile terminal 100 having a hinge assembly 30 in accordance with an exemplary embodiment of the present invention. Referring to FIG. 1, the wireless mobile terminal 100 includes a body 10 and a folder 20 rotatably connected to the body 10 through the hinge assembly 30.

The body 10 includes a body case 13, and a first wiring substrate 15 and first ground portion 17 embedded in the body case 13. The first wiring substrate 15 has various components required to operate the wireless mobile terminal 100, but the components are not essential to understand the present invention, and thus are not described in detail herein or shown in the drawings. The first ground portion 17 may have at least one of an electrically conductive layer formed on an inner surface of the body case 13 and a ground layer formed in the first wiring substrate 15. This embodiment shows a ground layer of the first wiring substrate 15 as the first ground portion 17.

The folder 20 includes a folder case 23, and a second wiring substrate 25 and second ground portion 27 embedded in the folder case 23. The second wiring substrate 25 may be a wiring substrate of a display installed on the folder 20. The second ground portion 27 may have at least one of an electrically conductive layer formed on an inner surface of the folder case 23 and a ground layer formed in the second wiring substrate 25. This example embodiment shows a ground layer of the second wiring substrate 25 as the second ground portion 27.

The hinge assembly 30 includes an electrically conductive hinge 40, and two contact connectors 51 and 53 connecting opposite ends of the hinge 40 to the first and second ground portions 17 and 27, respectively. The contact connectors 51 and 53 enable or disable electrical connections between the hinge 40 and the first and second ground portions 17 and 27 according to the positions of the contact connectors relative to the hinge 40 and whether the folder 20 is open or closed.

Therefore, the wireless mobile terminal 100 in accordance with this exemplary embodiment enables a selective electrical connection to the first and second ground portions 17 and 27 through the hinge assembly 30, and thus it may be assembled to reduce the SAR value and optimize the performance of an antenna according to the type of the wireless mobile terminal 100, when opening or closing the folder 20.

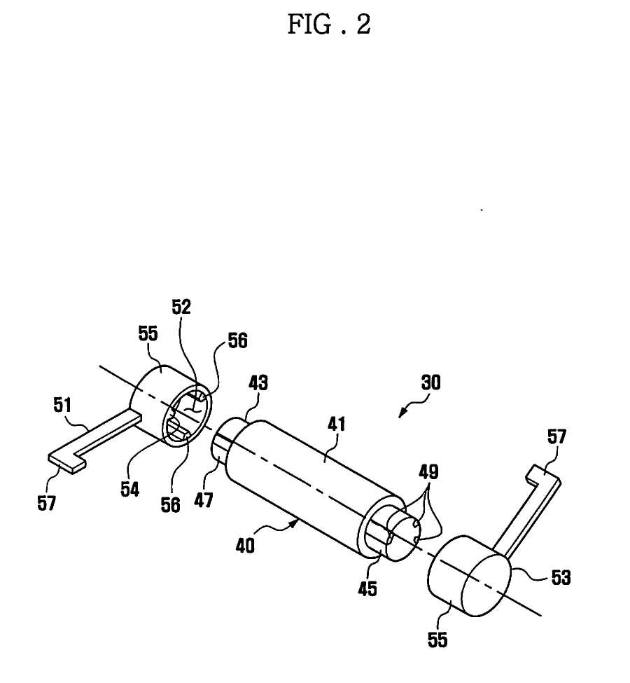

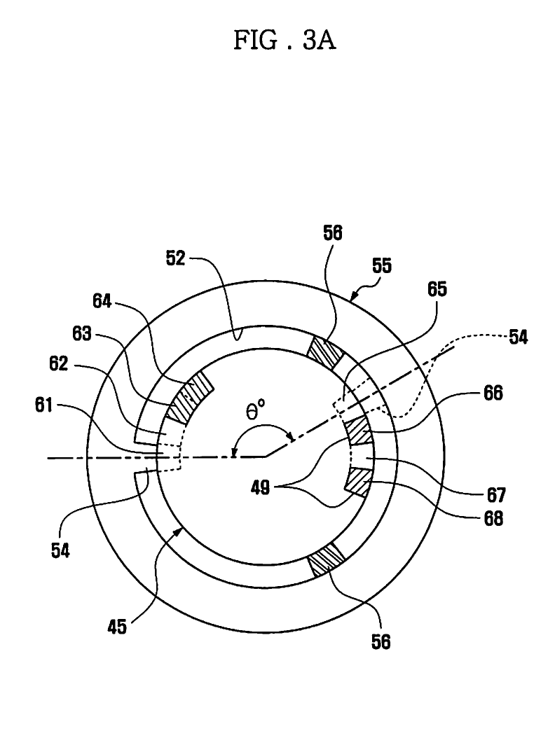

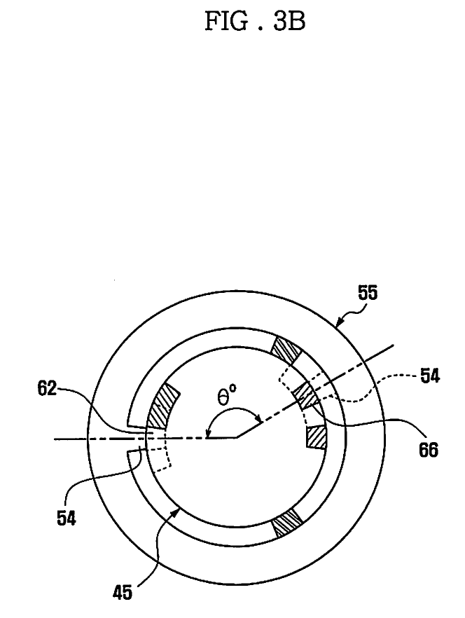

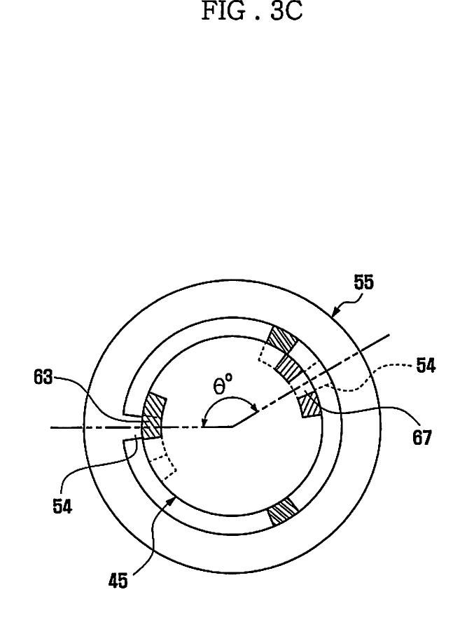

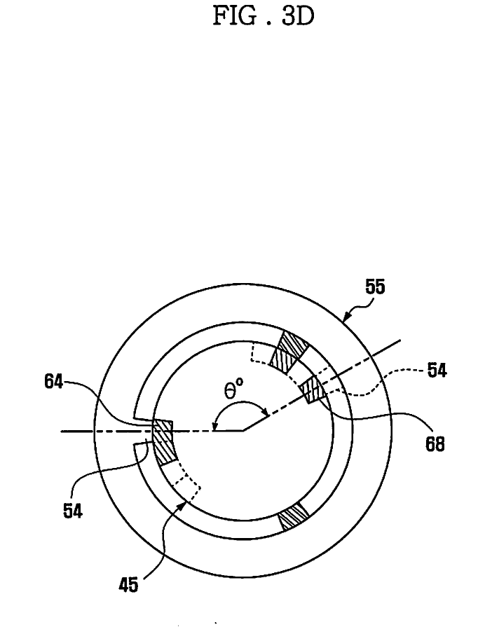

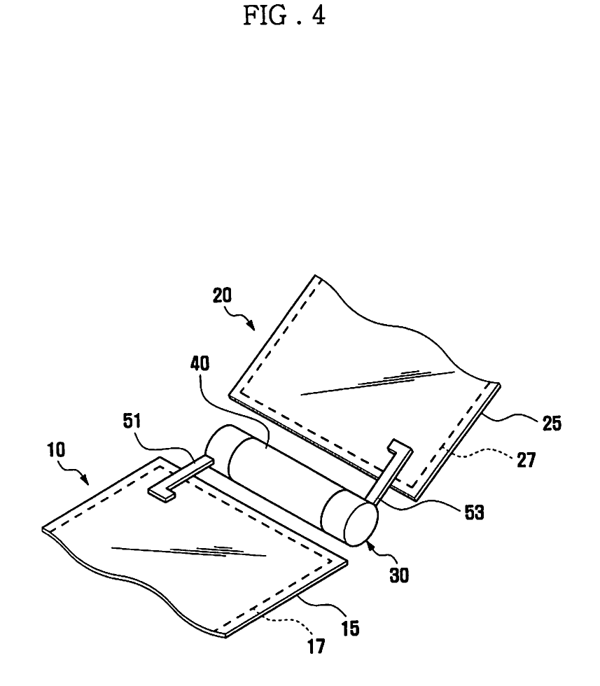

The hinge assembly 30 of the wireless mobile terminal 100 in accordance with this exemplary embodiment is described in detail with reference to FIGS. 2 to 4. FIG. 2 is an exploded perspective view of the hinge assembly 30 of FIG. 1. FIGS. 3A to 3D are cross-sectional views illustrating a first connecting portion 55 of a second contact connector 53 coupled to a second coupling portion 45 of FIG. 2. FIG. 4 is a view illustrating a first ground portion 17 and a second ground portion 27 connected to the hinge assembly 30 of FIG. 2.

The hinge 40 includes an electrically conductive hinge body 41 and two coupling portions 43 and 45 protruding outwards from the opposite ends of the electrically conductive hinge body 41, wherein the coupling portions 43 and 45 are located on the axis of rotation of the hinge body 41. The coupling portions 43 and 45 include a first coupling portion 43 installed at one end of the hinge body 41 and a second coupling portion 45 installed at the opposite end of the hinge body 41.

Each of the coupling portions 43 and 45 has coupling protrusions 47 extending in the direction of the axis of rotation of the hinge body 41, and a plurality of contact pads 49 arranged along the outer periphery of the coupling protrusions 47 in the direction of the axis of rotation of the hinge body 41. The coupling protrusions 47 are formed such that they have an electrical conductivity opposite to that of the contact pads 49. In this exemplary embodiment, the coupling protrusions 47 are electrically conductive and the contact pads 49 are electrically insulating.

The contact connectors 51 and 53 include a first connecting portion 55 having an insertion groove 52, whereby the coupling portions 43 and 45 are inserted into the insertion groove 52 of the contact connectors 51 and 53, respectively, and a second connecting portion 57 integrated with the first connecting portion 55 and connecting the contact connectors 51 and 53 to the ground portions 17 and 27, respectively. A contact protrusion 54 is formed on the inner periphery of the insertion groove 52 of the first connecting portion 55 and is in contact with the outer periphery of the coupling protrusions 47 and of the contact pads 49. Further, at least one dummy protrusion 56 is formed on the inner periphery of the insertion groove 52 of the first connecting portion 55 so that the contact protrusion 54 is in a stable contact with the outer periphery of the coupling protrusions 47. The dummy protrusion 56 is made of an electrically insulating material. The contact protrusion 54 and the dummy protrusion 56 are arranged at equal included angles with regard to the center of the insertion groove 52. This exemplary embodiment shows one contact protrusion 54 and two dummy protrusions 56 arranged at 120 degrees of included angle. The second connecting portion 57 may be in contact with or electrically bonded to the first and second ground portions 17 and 27 regardless of the opening or closing of the folder 20.

The contact connectors 51 and 53 include a first contact connector 51 for connecting the first coupling portion 43 to the first ground portion 17, and a second contact connector 53 for connecting the second coupling portion 45 to the second ground portion 27. The first contact connector 51 is connected to the first ground portion 17 and the second contact connector 53 is connected to the second ground portion 27, and thus the first contact connector 51 and the second contact connector 53 rotate in opposite directions when opening or closing the folder 20.

Meanwhile, the first contact connector 51 coupled to the first coupling portion 43 and the second contact connector 53 coupled to the second coupling portion 45 operate in the same manner, except for the direction of rotation, and thus the following description is made based on the second contact connector 53 coupled to the second coupling portion 45.

As shown in FIGS. 3A to 3D, the second contact connector 53 is coupled to the second coupling portion 45 in four manners according to the opening or closing of the folder 20. When opening or closing the folder 20, the second coupling portion 45 maintains a fixed position and the first connecting portion 55 of the second contact connector 53 rotates. The second coupling portion 45 is rotated to adjust the coupling position between the second coupling portion 45 and the first connecting portion 55. In the drawings, the direction of 9 o'clock represents the closed state of the folder 20, and rotation at a predetermined angle (Θ) in a clockwise direction represents the open state of the folder 20. At this time, in the case that the angle of the folder 20 in the closed state is 0 degree, the angle (Θ) of the folder 20 in the open state may be between 90 and 180 degrees.

The contact pads 49 are arranged along the outer periphery of the coupling protrusions 47 so that the second contact connector 53 is coupled to the second coupling portion 45 in four manners according to the opening or closing of the folder 20. When opening or closing the folder 20, the contact protrusion 54 contacts the outer periphery of the coupling protrusions 47 or the contact pads 49, and peripheral areas of the coupling protrusion 47 that may contact the contact protrusion 54 are hereinafter referred to as peripheral pads 61, 62, 65 and 67. The contact pads 49 include contact pads 63, 64, 66 and 68. The term “pads 61 to 68” includes the peripheral pads 61, 62, 65 and 67, and the contact pads 63, 64, 66 and 68. The peripheral pads 61, 62, 65 and 67 may themselves be the outer peripheral portions of the coupling protrusions 47, but may also be separately formed in the same manner as the contact pads 49.

When the folder 20 is closed, the contact protrusion 54 is located at the 0 degree position, and when the folder 20 is open, the contact protrusion 54 is located at the Θ degrees position. When opening or closing the folder 20, the position of the coupling protrusions 47 is adjusted so that the pads 61 to 68 are arranged corresponding to the position of the contact protrusion 54.

As shown in FIG. 3A, the pads 61 to 68 are arranged in two groups having substantially the same size, in a clockwise direction, one group starting from 0 degree and the other group starting from Θ degrees. That is, a first peripheral pad 61, a second peripheral pad 62, a third contact pad 63 and a fourth contact pad 64 are arranged sequentially in a clockwise direction, starting from the 0 degree position (i.e., the 9 o'clock position in FIGS. 3A-3D). A fifth peripheral pad 65, a sixth contact pad 66, a seventh peripheral pad 67 and an eighth contact pad 68 are arranged sequentially in a clockwise direction, starting from the Θ degrees position. At this time, an angle between an nth pad and an (n+4)th pad is Θ degrees (n is a natural number from 1 to 4). Further, the pads 61 to 68 are preferably formed to have contact area of each pad at least as large as a contact area of the contact protrusion 54 so as to accurately enable or disable the electrical connection between the contact protrusion 54 and the pads 61 to 68.

In this embodiment, the third contact pad 63 and the fourth contact pad 64 are shown as integrally formed, however the third contact pad 63 and the fourth contact pad 64 may be formed separately to each other. Further, the fifth to eighth pads 65 to 68 may be arranged in the same sequence but starting from the 0 degree position, and the first to fourth pads 61 to 64 may be arranged in the same sequence but starting from the E degrees position.

The hinge assembly 30 is electrically connected to the second ground portion 27 in four manners based on the coupling manner between the second coupling portion 45 and the first connecting portion 55 of the second contact connector 53 according to the opening or closing of the folder 20, and description is made in detail as follows.

First, referring to FIG. 3A, the second coupling portion 45 is coupled to the first connecting portion 55 in such a manner that the hinge assembly 30 is electrically connected to the second ground portion 27 when the folder 20 is open and closed. That is, the first peripheral pad 61 is arranged at the 0 degree position and the fifth peripheral pad 65 is arranged at the Θ degrees position. Accordingly, when the folder 20 is closed, the contact protrusion 54 contacts the first peripheral pad 61, and when the folder 20 is open, the contact protrusion 54 contacts the fifth peripheral pad 65, and thus when the folder 20 is open and closed, the second coupling portion 45 is electrically connected to the first connecting portion 55.

Second, referring to FIG. 3B, the second coupling portion 45 is coupled to the first connecting portion 55 in such a manner that the hinge assembly 30 is electrically connected to the second ground portion 27 only when the folder 20 is closed. That is, the second peripheral pad 62 is arranged at the 0 degree position, and thus when the folder 20 is closed, the contact protrusion 54 contacts the second peripheral pad 62, thereby enabling the electrical connection between the second coupling portion 45 and the first connecting portion 55. Also, the sixth contact pad 66 is arranged at the Θ degrees position, and thus when the folder 20 is open, the contact protrusion 54 contacts the sixth contact pad 66, thereby disabling the electrical connection between the second coupling portion 45 and the first connecting portion 55.

Third, referring to FIG. 3C, the second coupling portion 45 is coupled to the first connecting portion 55 in such a manner that the hinge assembly 30 is electrically connected to the second ground portion 27 only when the folder 20 is open. That is, the third contact pad 63 is arranged at the 0 degree position, and thus when the folder 20 is closed, the contact protrusion 54 contacts the third contact pad 63. Accordingly, the electrical connection between the second coupling portion 45 and the first connecting portion 55 is disabled. Also, the seventh peripheral pad 67 is arranged at the Θ degrees position, and thus when the folder 20 is open, the contact protrusion 54 contacts the seventh peripheral pad 67, thereby enabling the electrical connection between the second coupling portion 45 and the first connecting portion 55.

Fourth, referring to FIG. 3D, the second coupling portion 45 is coupled to the first connecting portion 55 in such a manner that the electrical connection is disabled between the hinge assembly 30 and the second ground portion 27 when the folder 20 is open and closed. That is, the fourth contact pad 64 is arranged at the 0 degree position, and the eighth contact pad 68 is arranged at the Θ degrees position. Accordingly, when the folder 20 is closed, the contact protrusion 54 contacts the fourth contact pad 64, and when the folder 20 is open, the contact protrusion 54 contacts the eighth contact pad 68, thereby disabling the electrical connection between the second coupling portion 45 and the first connecting portion 55 when the folder 20 is open and closed.

Further, the first coupling portion 43 is coupled to the first connecting portion 55 of the first contact connector 51 in the same manner, and thus the hinge assembly 30 may be electrically connected to the first ground portion 17 in four manners based on the coupling manner between the first coupling portion 43 and the first contact connector 51 according to the opening or closing of the folder 20. At this time, when opening or closing the folder 20, the first contact connector 51 maintains a fixed position and the first coupling portion 43 rotates. The first coupling portion 43 is rotated to adjust the coupling position between the first coupling portion 43 and the first contact connector 51.

The wireless mobile terminal 100 according to the present invention may enable four manners of electrical connections according to the opening or closing of the folder 20. Thus, if the possible electrical connection manners are all combined according to the opening or closing of the folder 20, as shown in Table 1, the hinge assembly 30 may be coupled to the first ground portion 17 and the second ground portion 27 in sixteen manners. In Table 1, “o” means that the corresponding first and second ground portions 17 and 27 are electrically connected to the hinge assembly 30, and “X” means that electrical connections between the corresponding first and second ground portions 17 and 27 and the hinge assembly 30 are disabled.

TABLE 1

| | |
|---|---|
| Open folder | Closed folder |

| First ground | Second | First ground | Second |
|---|---|---|---|
| portion | ground | portion | ground |
| ◯ | ◯ | ◯ | ◯ |
| ◯ | ◯ | ◯ | X |
| ◯ | ◯ | X | ◯ |
| ◯ | ◯ | X | X |
| ◯ | X | ◯ | ◯ |
| ◯ | X | ◯ | X |
| ◯ | X | X | ◯ |
| ◯ | X | X | X |
| X | ◯ | ◯ | ◯ |
| X | ◯ | ◯ | X |
| X | ◯ | X | ◯ |
| X | ◯ | X | X |
| X | X | ◯ | ◯ |
| X | X | ◯ | X |
| X | X | X | ◯ |
| X | X | X | X |

Although exemplary embodiments of the present invention have been described in detail hereinabove, it should be understood that many variations and modifications of the basic inventive concept herein described, which may appear to those skilled in the art, will still fall within the spirit and scope of the exemplary embodiments of the present invention as defined in the appended claims.

For example, this exemplary embodiment shows that, when the ground portions are electrically connected to the second connecting portions of the contact connectors, the electrical connection between the ground portions and the hinge assembly is enabled or disabled according to the electrical connection by contact between the hinge and the first connecting portions of the contact connectors, however the present invention is not limited in this regard. That is, the second connecting portions may be mechanically connected to or separated from the ground portions according to coupling by the electrical connection between the hinge and the first connecting portions of the contact connectors, so that the electrical connection between the ground portions and the hinge assembly is enabled or disabled.

Further, this exemplary embodiment shows the contact protrusion located corresponding to the position where the folder is open or closed, but if the first to eighth pads are arranged at the position of the contact protrusion when opening or closing the folder, the contact protrusion may be located at any other position.

According to the configuration of the present invention, the hinge assembly is selectively electrically connected to the first and second ground portions, and thus, when opening or closing the folder, the same hinge assembly can be assembled in consideration of the SAR value and the radiating performance of an antenna according to the type of a wireless mobile terminal.

Therefore, the present invention selectively enables or disables the electrical connections between the hinge assembly and the first and second ground portions, thereby reducing the SAR level or optimizing the performance of the antenna according to the opening or closing of the folder.

What is claimed is:

1. A hinge assembly for a wireless mobile terminal including a body having a first ground portion and a folder having a second ground portion, the hinge assembly comprising:
a hinge being electrically conductive and having a first coupling portion and a second coupling portion, each coupling portion formed at one of two opposite ends of the hinge; and
two contact connectors being electrically conductive, each contact connector having a first part coupled to one of the first and second coupling portions and a second part connected to one of the first and second ground portions, for enabling or disabling electrical connections between the hinge and the respective ground portion according to a position of the contact connector and a rotation of the contact connector.

2. The hinge assembly of claim 1, wherein the hinge comprises a hinge body being electrically conductive, and the two coupling portions protruding outwards respectively at opposite ends of the hinge body and are located on a rotation axis of the hinge body.

3. The hinge assembly of claim 2, wherein each of the coupling portions comprises:
coupling protrusions extending in the direction of the rotation axis; and
contact pads arranged along the outer periphery of the coupling protrusions in the direction of the rotation axis.

4. The hinge assembly of claim 3, wherein the coupling protrusions have an electrical conductivity opposite to that of the contact pads.

5. The hinge assembly of claim 4, wherein each of the contact connectors comprises:
a first connecting portion having an insertion groove into which one of the coupling portions is inserted; and
a second connecting portion integrated with the first connecting portion and connected to one of the ground portions.

6. The hinge assembly of claim 5, wherein the first connecting portion comprises a contact protrusion formed on an inner periphery of the insertion groove, the contact protrusion contacting an outer periphery of the coupling protrusions and of the contact pads.

7. The hinge assembly of claim 6, wherein the first connecting portion further comprises at least one dummy contact protrusion formed on the inner periphery of the insertion groove, wherein the contact protrusion and the at least one dummy contact protrusion are arranged at a predetermined included angle with regard to the center of an insertion groove.

8. The hinge assembly of claim 7, wherein each of the coupling portions comprises:
a plurality of peripheral pads; and
a plurality of the contact pads,
wherein the peripheral pads and the contact pads are arranged along the outer periphery of the coupling protrusion corresponding to the position of the contact protrusion according to an opening or closing of the folder.

9. The hinge assembly of claim 8, wherein,
when the folder is closed, a first peripheral pad, a second peripheral pad, a third contact pad and a fourth contact pad are arranged in a sequential order along the outer periphery of the coupling protrusions corresponding to a first position of the contact protrusion; and
when the folder is open, a fifth peripheral pad, a sixth contact pad, a seventh peripheral pad and an eighth contact pad are arranged in a sequential order on the outer periphery of the coupling protrusions corresponding to a second position of the contact protrusion, and
an angle between an nth pad and an (n+4)th pad (where n is a natural number from 1 to 4) is equal to a predetermined open angle of the folder.

10. A wireless mobile terminal having a hinge assembly, the wireless mobile terminal comprising:
a body having a first ground portion;
a folder having a second ground portion; and
the hinge assembly for electrically connecting the first and second ground portions and for rotatably connecting the folder and the body, wherein the hinge assembly includes a hinge being electrically conductive and having two coupling portions formed at opposite ends of the hinge, and two contact connectors being electrically conductive, each contact connector having a first part coupled to one of the coupling portions and a second part connected to one of the ground portions, for enabling or disabling electrical connections between the hinge and the respective ground portion according to a position of the contact connector coupled to the coupling portions and a rotation of the contact connector.

11. The wireless mobile terminal of claim 10, wherein the body comprises:
a body case having a first conductive layer formed on an inner surface of the body case; and
a first wiring substrate embedded in the body case and having a first ground layer, wherein the first ground portion is at least one of the first conductive layer and the first ground layer.

12. The wireless mobile terminal of claim 11, wherein the folder comprises:
a folder case having a second conductive layer formed on an inner surface of the folder case; and
a second wiring substrate embedded in the folder case and having a second ground layer, wherein the second ground portion is at least one of the second conductive layer and the second ground layer.

13. The wireless mobile terminal of claim 12, wherein the hinge further comprises a conductive hinge body, and the two coupling portions protrude outwards respectively at opposite ends of the hinge body and are located on a rotation axis of the hinge body.

14. The wireless mobile terminal of claim 13, wherein each of the coupling portions comprises:
coupling protrusions extending in the direction of the rotation axis; and
contact pads arranged along an outer periphery of the coupling protrusions in the direction of the rotation axis.

15. The wireless mobile terminal of claim 14, wherein the coupling protrusions have an electrical conductivity opposite to that of the contact pads.

16. The wireless mobile terminal of claim 15, wherein each of the contact connectors comprises:
a first connecting portion having an insertion groove into which one of the coupling portions is inserted; and
a second connecting portion integrated with the first connecting portion and connected to one of the ground portions.

17. The wireless mobile terminal of claim 16, wherein the first connecting portion comprises a contact protrusion formed on an inner periphery of the insertion groove, the contact protrusion contacting an outer periphery of the coupling protrusions and of the contact pads.

18. The wireless mobile terminal of claim 17, wherein the first connecting portion further comprises at least one dummy contact protrusion formed on the inner periphery of the insertion groove, wherein the contact protrusion and the dummy contact protrusion are arranged at a predetermined included angle with regard to the center of the insertion groove.

19. The wireless mobile terminal of claim 18, wherein each of the coupling portions comprises:
a plurality of peripheral pads; and
a plurality of the contact pads,
wherein the peripheral pads and the contact pads are arranged along the outer periphery of the coupling protrusion corresponding to the position of the contact protrusion according to opening or closing of the folder.

20. The wireless mobile terminal of claim 19, wherein,
when the folder is closed, a first peripheral pad, a second peripheral pad, a third contact pad and a fourth contact pad are arranged sequentially along the outer periphery of the coupling protrusions corresponding to a first position of the contact protrusion; and
when the folder is open, a fifth peripheral pad, a sixth contact pad, a seventh peripheral pad and an eighth contact pad are arranged sequentially on the outer periphery of the coupling protrusions corresponding to a second position of the contact protrusion, and
an angle between an nth pad and an (n+4)th pad (where n is a natural number from 1 to 4) is equal to a predetermined open angle of the folder.
